(19) United States
(12) Patent Application Publication
(10) Pub. No.: US 2007/0088766 A1
(43) Pub. Date: Apr. 19, 2007

(54) Method and system for capturing and storing multiple versions of data item definitions

(75) Inventors: Andrew Heath Bodge, Acton, MA (US); Harish Akali, Merrimack, NH (US); Luming Han, Bedford, NH (US); Xiaolan Shen, Nashua, NH (US)

Correspondence Address: BINGHAM MCCUTCHEN LLP, 3000 K STREET, NW, BOX IP, WASHINGTON, DC, 20007, US

(73) Assignee: Oracle International Corporation

(21) Appl. No.: 11/250,545

(22) Filed: Oct. 17, 2005

(51) Int. Cl. G06F 17/30

(52) U.S. Cl. 707/203

(57) ABSTRACT

A method, system and computer program product provides the capability to capture and store data object definitions in a database in a less costly and less time-consuming manner than previous techniques. A method of capturing and storing multiple versions of data item definitions in a database comprises generating a first version of information relating to a plurality of data item definitions in the database, and generating a second version of information relating to a plurality of data item definitions in the database by recapturing only information relating to those data item definitions that have changed since the first version was generated.

### BACKGROUND OF THE INVENTION

1. Field of the Invention

The present invention relates to a system, method, and computer program product for capturing and storing multiple versions of data item definitions.

2. Description of the Related Art

A database management system (DBMS) provides the capability to store, organize, modify, and extract information from one or more databases included in the DBMS. From a technical standpoint, DBMSs can differ widely. The terms relational, network, flat, and hierarchical all refer to the way a DBMS organizes information internally. The internal organization can affect how quickly and flexibly you can extract information.

Each database included in a DBMS includes a collection of information and other objects organized in such a way that computer software can select and retrieve desired pieces of data. Traditional databases are organized by fields, records, and files. A field is a single piece of information; a record is one complete set of fields; and a file is a collection of records. Most full-scale database systems are relational database systems. An important feature of relational systems is that a single database can be spread across several tables. This differs from flat-file databases, in which each database is self-contained in a single table. In fact, large relational database systems may include a large number of tables and other data objects, such as indexes, etc. In order for a data object to exist in a database, the data object and its characteristics must be defined by a data object definition. Typically, such data object definitions are stored as metadata of the data objects. Taken together, all the data object definitions define the design of the database. Typically, the data objects are organized by schemas, each of which includes at least a portion of the data object definitions.

As the design of a database system changes over time, it is important to database developers and administrators to be able to track the changes in the data object definitions of the database. The task is to capture and store a specified set of database metadata object definitions, then to repeat the process at later points in time using the same selection criteria. Conventionally, all metadata object definitions that met the selection criteria are captured and stored each time the process is repeated. This is a costly and time-consuming process. A need arises for a technique by which data object definitions may be captured and stored that reduces the cost and time of the process.

### SUMMARY OF THE INVENTION

The present invention provides the capability to capture and store data object definitions in a database in a less costly and less time-consuming manner than previous techniques. Using the present invention, after an initial set of metadata definitions has been captured, only those definitions that have changed since the last time the definitions were captured are again captured and stored. The present invention provides a way to store only changed definitions, which allows efficient retrieval of the complete set of definitions as they existed at each point of capture, and algorithms for efficiently determining which definitions have changed since the last point of capture.

In one embodiment of the present invention, a method of capturing and storing multiple versions of data item definitions in a database comprises generating a first version of information relating to a plurality of data item definitions in the database, and generating a second version of information relating to a plurality of data item definitions in the database by recapturing only information relating to those data item definitions that have changed since the first version was generated.

In one aspect of the present invention, the first version may be generated by capturing information relating to all data item definitions in the database. The first version may be generated by capturing information relating to all data item definitions in the database meeting specified criteria. The first version may be generated by obtaining information relating to a plurality of data item definitions, the information including at least the key characteristic value(s) of the data item and a delta value for current characteristics of the data item and storing the information relating to each data item. The second version may be generated by determining which data item definitions have changed since the first version was generated using an ordered list of data item definitions and associated delta values.

In one aspect of the present invention, the second version may be generated by obtaining a first list of data items definitions in the database that meet the specified criteria, each entry in the list including at least the key characteristic value(s) of the data item and a delta value for current characteristics of the data item, wherein the list is ordered by values of the key characteristic(s), obtaining a second list of data item definitions in the first version, each entry in the list including at least the key characteristic value(s) of the data item as included in the first version and a delta value for characteristics of the data item as included in the first version, wherein the list is ordered by values of the key characteristic(s), and comparing the first list and the second list to determine which data item definitions have changed. Comparing the first list and the second list to determine which data item definitions have changed may be performed by, for each entry in the first list if the data item is present in the first list, but not present in the second list, adding the data item to the second version, if the data item is present in the second list, but not present in the first list, removing the data item from the second version, if the data item is present in the first list and in the second list, and if the delta value of the data item has changed, updating the data item in the second version, and generating the second version by recapturing only information relating to those data item that have been added to or updated in the second version.

In one aspect of the present invention, the second version may be generated by obtaining a first list of data items definitions in the database that meet the specified criteria, each entry in the list including at least the key characteristic value(s) of the data item and a delta value for current characteristics of the data item, wherein the list is unordered, obtaining a second list of data item definitions in the first version, each entry in the list including at least the key characteristic value(s) of the data item as included in the first version and a delta value for characteristics of the data item as included in the first version, and comparing the first list and the second list to determine which data item definitions have changed. Comparing the first list and the second list to determine which data item definitions have changed may be performed by, storing the delta values from the second list, for each entry in the first list, if the delta value of the entry is present in the second list, removing the delta value from the stored delta values, if the delta value of the entry is not present in the second list, if the data item corresponding to the entry is present in the first version, updating the data item in the second version, if the delta value of the entry is not present in the second list, and if the data item corresponding to the entry is not present in the first version, adding the data item to the second version, removing data items from the second version having delta values remaining in the stored delta values, and generating the second version by recapturing only information relating to those data items with stored delta values that have been added to or updated in the second version. The delta values may be stored in a hash table.

### BRIEF DESCRIPTION OF THE DRAWINGS

Further features and advantages of the invention can be ascertained from the following detailed description that is provided in connection with the drawings described below:

FIG. 1 is a block diagram of a system in which the present invention may be implemented.

FIG. 2 is an exemplary illustration of a data item versions table.

FIG. 3 is an exemplary illustration of a data item versions table.

FIG. 4 is an exemplary illustration of a data item versions table.

FIG. 5 is an exemplary illustration of a data item versions table.

FIG. 6 is an exemplary flow diagram of an initial (first version) capture process.

FIG. 7 is an exemplary flow diagram of a process for performing a Lockstep recapture technique.

FIG. 8 is an exemplary flow diagram of a process for performing a Hash Table recapture technique.

FIG. 9 is an exemplary block diagram of a database system, in which the present invention may be implemented.

### DETAILED DESCRIPTION OF THE PREFERRED EMBODIMENTS

The present invention provides the capability to capture and store data object definitions in a database in a less costly and less time-consuming manner than previous techniques. Using the present invention, after an initial set of metadata definitions has been captured, only those definitions that have changed since the last time the definitions were captured are again captured and stored. The present invention provides a way to store only changed definitions, which allows efficient retrieval of the complete set of definitions as they existed at each point of capture, and algorithms for efficiently determining which definitions have changed since the last point of capture.

This present invention provides an efficient technique for capturing and storing the definitions of a set of data items, then repeating the process later to create a new set of definitions, and so on. The technique provides advantages in both execution time and storage space over the obvious approach of capturing and storing all the definitions, each time.

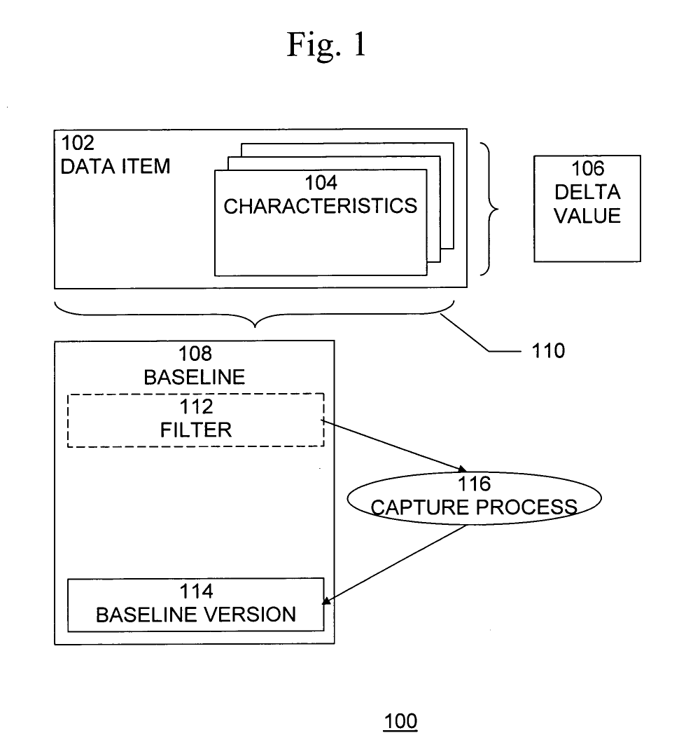

An example of a system 100 in which the present invention may be implemented is shown in FIG. 1. System 100 includes one or more data items 102, characteristics 104, delta values 106, and baselines 108. A data item 102 is a collection of related information stored in a computer. The individual pieces of information are the data item's characteristics 104. These characteristics may change over time. Data items may be created and destroyed over time. For example, the definition of a metadata object such as a table or index is a data item. Its characteristics may include its name, owner, columns, constraints and so on.

Key characteristics are a subset of a data item's characteristics that uniquely identify this data item among all others. For a given data item, the values of the key characteristics may not change during its lifetime. (If the value of a key characteristic does change, this is equivalent to destroying the data item and creating a new data item identified by the new key characteristic values.) It must be possible to efficiently and unambiguously sort a collection of data items based on their key values. For example, key characteristics may include a metadata object's type, owner, and name, such as TABLE SCOTT.TIGER or USER SCOTT.

A delta value 106 is a single, easily obtained value that is uniquely associated with a particular set of data item characteristic values. For a given data item, the delta value 106 is guaranteed to change each time one or more characteristic values changes. (If the set of characteristic values later returns to a previous configuration, the delta value 106 may or may not be the same as its previous value; the technique works in either case.) For example, a delta value 106 may be formed using a last-DDL timestamp indicating the last time that a metadata object's definition was modified, or a hash key calculated from the object's definition. A last-DDL timestamp distinguishes one version of a data item from other versions of the same data item that were modified at an earlier or later time. Other data items may have the same last-DDL timestamp. A hash key delta value, on the other hand, is uniquely associated with a single version of a single data item.

A baseline 108 is specification for capturing data items from a computer, including a source 110 of data items, such as a database, and a filter 112, which data item key values must pass in order to be included. For example, the filter 112 may specify inclusion of indexes and tables owned by user SCOTT. A baseline's source 110 and filter 112 may not be changed after the baseline 108 has been created. A baseline may also contain zero or more baseline versions 114 that have been captured using the specification. It is to be noted that the filter part 112 of the specification is optional (that is, not a necessary component of the technique). A baseline may capture all data items that are available from the source.

A baseline version 114 is a set of data items captured at a point in time. The baseline version 114 includes those data items that were present in the source, and that passed the filter, at the time of capture. The baseline version 114 preserves the characteristics of each data item as they existed at the time of capture. A baseline version 114 has a version number that distinguishes it from other versions of the same baseline. Once captured, a baseline version 114 may be deleted, but it may not be modified.

A data item version includes the values of a data item's characteristics at a particular point in time. A data item version may appear in one or more consecutive baseline versions; this indicates that the data item's characteristics have not changed during the time those baseline versions were captured.

Capture process 116 creates a baseline version 114 by determining which data items currently pass the filter, and storing the identities and characteristics of those data items.

In the prior art, each baseline version physically contains all the data items that match the filter at the time of capture. It may take a great deal of time and space to store all the data items. The present invention, however, takes advantage of the likelihood that, from one baseline version to the next, only a small percentage of the data items will change (or be created, or be deleted). The present invention captures and stores only those data items that have changed since the last baseline version. This is invisible to the user. Each baseline version appears to be complete. The technique described here makes this possible.

The key components of the technique are the following:
A versioning scheme. The versioning scheme allows a single data item definition to appear in more than one baseline version. For example, if a data item is first seen in baseline version 2, is unchanged through versions 3 and 4, then changes before version 5 is captured, the definition captured with version 2 also appears in versions 3 and 4. The versioning scheme permits efficient retrieval of all the data items included in a particular baseline version.
Capture algorithms. The capture algorithms use the delta value associated with each data item to quickly determine if a data item has changed since the last baseline version. For baseline versions after the first, the capture algorithm stores only those data items that have changed, or have been added, since the last baseline version. If a data item has been deleted since the last baseline version, the capture algorithm does not include it in the current version. Data items that have not changed since the previous version are not stored, and are allowed to appear in the current version.

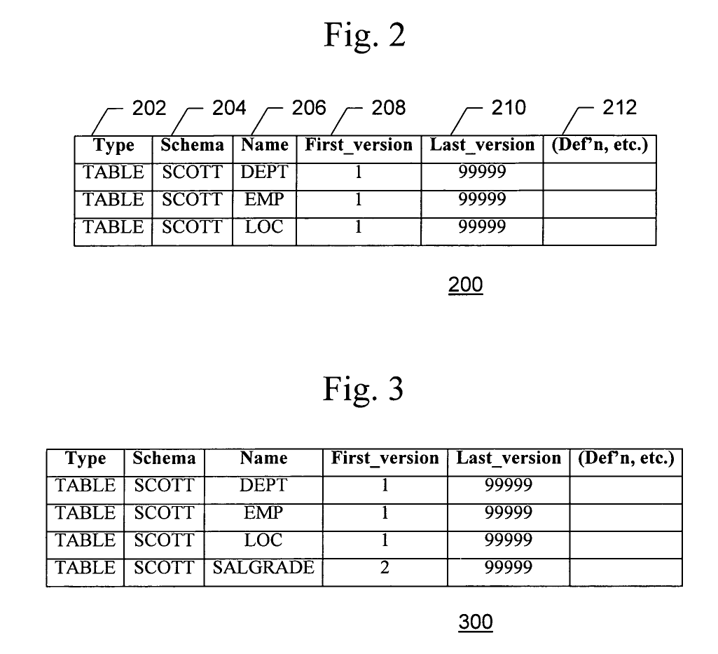

The versioning scheme has two main components, storage and operations. Regarding the storage component, each captured data item definition is stored in one or more database tables. There is one table in particular (the “data item versions table”) that contains a single row for each data item definition. An example of such a table is shown in FIG. 2. This table preferably contains at least the following columns:
A column containing an identifier used to group all data items that belong to a particular baseline.
One or more columns that contain the data item's key characteristics values.
One column that contains the delta value for this version of the data item.
A numeric column, FIRST_VERSION, which identifies the first baseline version in which a data item version appears.
A numeric column, LAST_VERSION, which identifies the last baseline version in which a data item version appears. This column contains an arbitrarily high value (e.g., 99999) if the data item version appears in the most recent baseline version.

One or more additional columns may be used to store the data item's remaining (non-key) characteristics, or these characteristics may be stored in other tables that are linked to the data item versions table by some means. An example of a data item versions table 200 after the initial capture (baseline) is shown in FIG. 2. In this example, the baseline selects tables in schema SCOTT. In this example, table 200 includes columns such as type column 202, indicating the type of the object included in the baseline, schema column 204, indicating the schema of the object, name column 206, indicating the name of the object, first capture version column 208, indicating the version number of the capture in which the item first appears, and last capture version column 210, indicating the version number of the capture in which the item last appears. Columns 202, 204, and 206 together contain the data item's key characteristics. Table 200 is a baseline, so all items present in the baseline at this point first appeared in capture version 1.

In the example shown in FIG. 3, table SALGRADE has been added to the schema SCOTT, and capture version 2 is captured. Table 300 includes the entries from table 200, plus the entry for table SALGRADE, which first appeared in capture version 2.

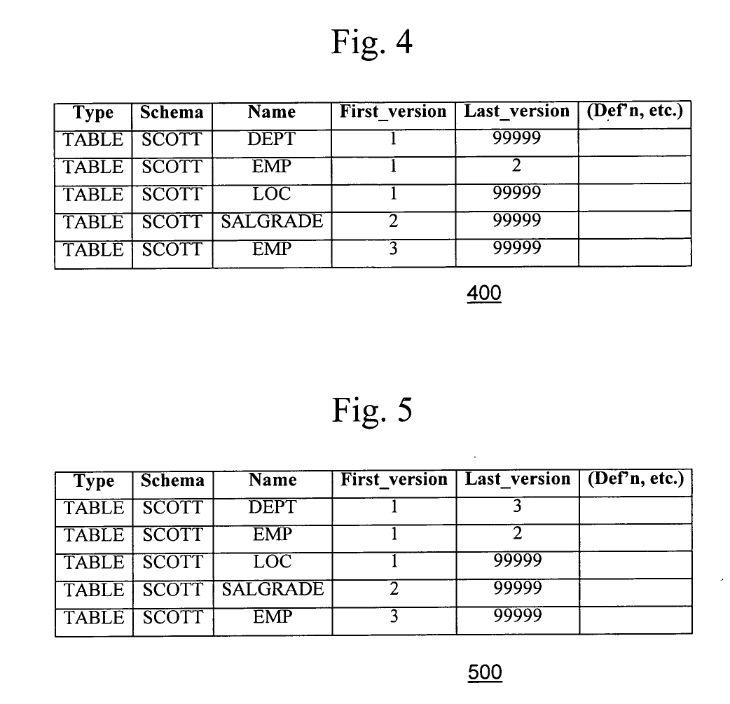

In the example shown in FIG. 4, table EMP has been modified, and capture version 3 is captured as shown in Table 400. The original version of table EMP first appeared in capture version 1 and last appeared in capture version 2, while the modified version of table EMP first appeared in capture version 3.

In the example shown in FIG. 5, table DEPT is dropped, and version 4 is captured as shown in Table 500. Table DEPT now has a last version of capture version 3.

Regarding the operations component of the versioning scheme, how fundamental operations are carried out on the data item versions table is described below.

Add a New Data Item Version to a Baseline Version: While capturing a new version n of baseline b, it is determined that a data item with key characteristic values (k1=X, k2=Y) has been added since the last baseline version. Add a row to the data item versions table with values:
Baseline identifier column: baseline ID b
Key characteristic columns: k1=X, k2=Y
Delta value column: delta value for this data item version
FIRST_VERSION: n
LAST_VERSION: 99999
   Store the data item's characteristics in additional data item versions table columns or in other tables, as appropriate.

Remove a Data Item Version from a Baseline Version: While capturing a new version n of baseline version b, it is determined that a data item with key characteristic values (k1=Q, k2=R) has been deleted since the last baseline version. Determine the number of the previous version (before n) pv. Find a row in the data item versions table having values:
Baseline identifier column: baseline ID b
Key characteristic columns: k1=Q, k2=R
LAST_VERSION: 99999
   Update this row as follows:
LAST_VERSION: pv

Update a Data Item Version in a Baseline Version: While capturing a new version n of baseline version b, it is determined that a data item with key characteristic values (k1=S, k2=T) has changed since the last baseline version. Carry out the “Remove a Data Item Version” operation, followed by the “Add a Data Item Version” operation, for data item (k1=S, k2=T).

Retrieve Data Items that Constitute a Baseline Version: To retrieve all the data items that constitute version n of baseline b, find the data item versions table rows that meet the following criteria:
Baseline identifier column: baseline ID b
FIRST_VERSION: <=n
LAST_VERSION: >=n

Retrieve All Versions of a Data Item: To retrieve all the versions from baseline b of a data item with key characteristic values (k1=X, k2=Y), find the data item versions table rows that meet the following criteria:
Baseline identifier column: baseline ID b
Key characteristic columns: k1=X, k2=Y

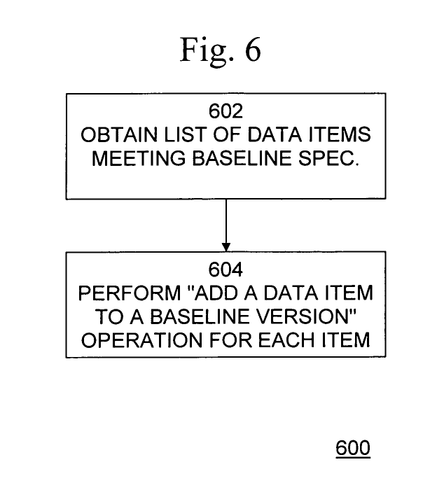

An example of an initial (first version) capture process 600 is shown in FIG. 6. In order to capture version 1 (the first version) of baseline b, the process begins with step 602, in which a list of the data items meeting the baseline specification is obtained. The list need not be sorted. Each entry in the list includes at least the following information:
a) The key characteristic values for the data item
b) The delta value for the data item's current set of characteristics

In step 604, for each entry in the list, carry out the “Add a Data Item to a Baseline Version” operation described above.

After the initial (baseline) capture, the state of the database configuration may be recaptured as desired—periodically, based on the occurrence or non-occurrence of some event, or at will. There are two different techniques that may used to perform the recapture process. Depending on the types of objects included in the baseline, either or both may be used during recapture:
The “lockstep technique” is used when an ordered list of data items with their delta values can efficiently be obtained from the baseline source.
The “hash table technique” is used when an ordered list of data items with their delta values cannot efficiently be obtained from the baseline source, but an unordered list can be.

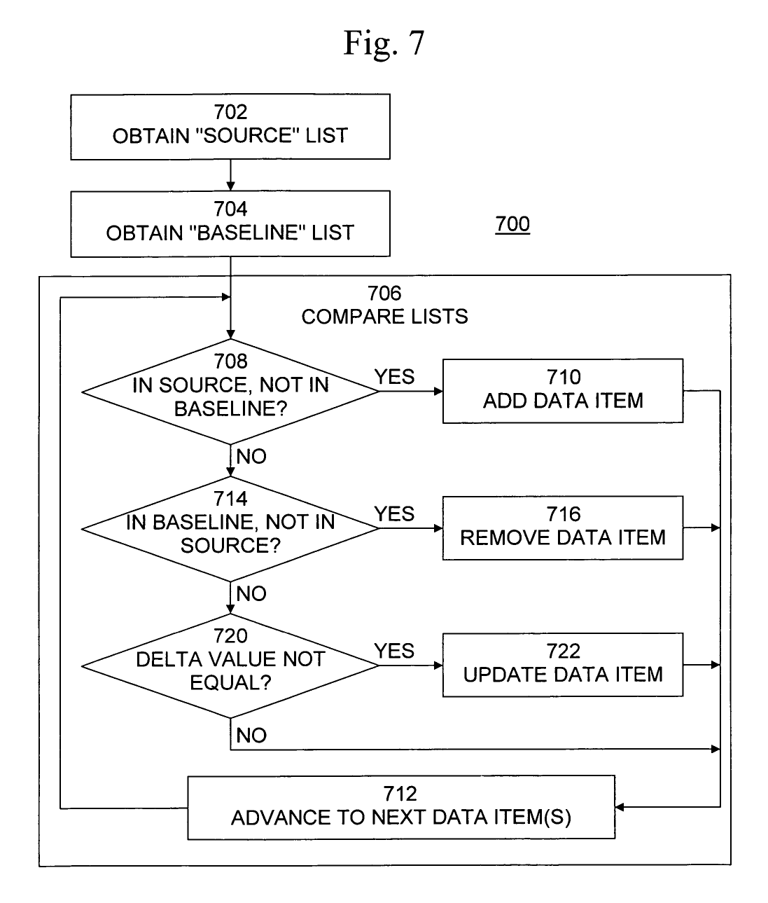

An example of a process 700 for performing the Lockstep recapture technique is shown in FIG. 7. Process 700 captures a version n (where n>1) of baseline b. Process 700 begins with step 702, in which a list (the “source list”) of the data items in the baseline source that meet the baseline specification is obtained. Each entry in the list includes at least the following information:
The key characteristic values for the data item
The delta value for the data item's current set of characteristics
   The list is ordered by the key characteristics values.

In step 704, a list (the “baseline list”) of the data items in the baseline version preceding version n, is obtained using the technique described in “Retrieve Data Items that Constitute a Baseline Version” above. Each entry in the list includes the following information:
The key characteristic values for the data item as stored in the first version
The stored delta value for the data item's set of characteristics at the time the first version was captured
   The list is ordered by the key characteristics values.

In step 706, the two lists are compared as follows:

In step 708, it is determined whether the data item is present in the source list but not the baseline list. If so, the process continues with step 710, in which the “Add a New Data Item Version to a Baseline Version” operation is performed. The process then continues with step 712, in which the process advances the source list to the next data item, then loops back to repeat step 706 for the next data item.

If the condition in step 708 is not met, then the process continues with step 714, in which it is determined whether the data item is present in the baseline list but not the source list. If so, the process continues with step 716, in which the “Remove a Data Item from a Baseline Version” operation is performed. The process then continues with step 712, in which the process advances the baseline list to the next data item, then loops back to repeat step 706 for the next data item.

If the condition in step 714 is not met, then the data item is present in both the baseline list and the source list. The process continues with step 720, in which it is determined whether the delta values from the baseline data item and the source data items are not equal. If it is the case that the delta values are not equal, then the process continues with step 722, in which the “Update a Data Item Version in a Baseline Version” operation is performed. The process then continues with step 712, in which the process advances both the source and baseline lists to their next data items, then loops back to repeat step 706 for the next data item.

If the condition in step 720 is not met, the process then continues with step 712, in which the process advances both the source and baseline lists to their next data items, then loops back to repeat step 706 for the next data item.

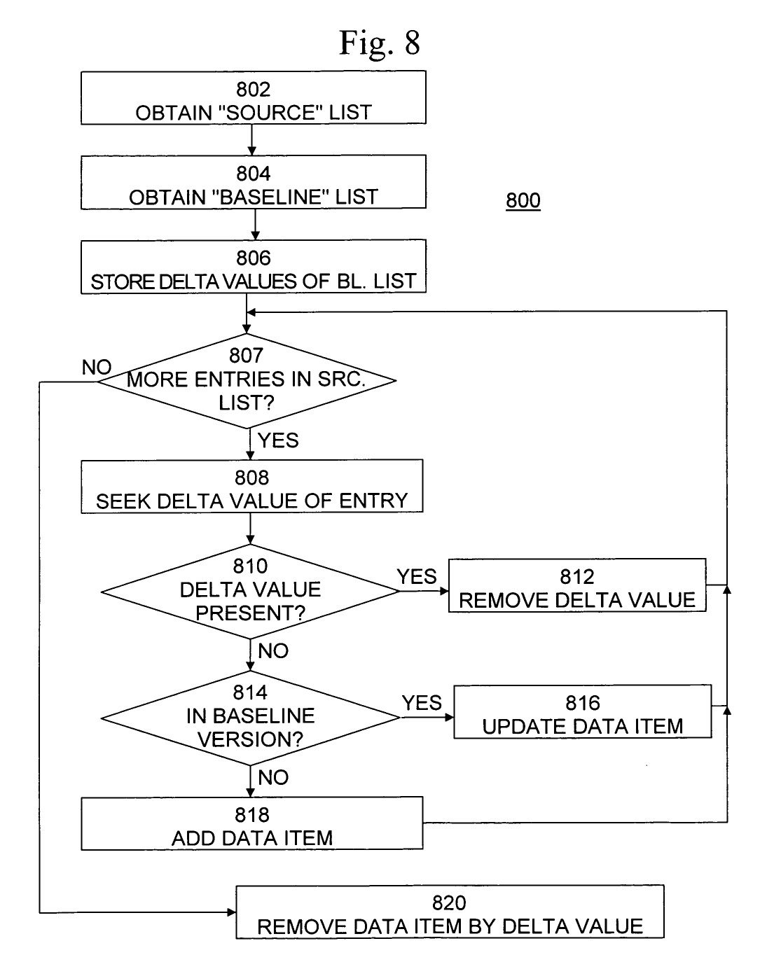

An example of a process 800 for performing the Hash Table recapture technique is shown in FIG. 8. Process 800 captures version n (where n>1) of baseline b. Process 800 begins with step 802, in which a list (the “source list”) of the data items in the baseline source that meet the baseline specification is obtained. Each entry in the list includes at least the following information:
The key characteristic values for the data item
The delta value for the data item's current set of characteristics
   The list is unordered.

In step 804, a list (the “baseline list”) of the data items in the baseline version preceding version n, is obtained using the technique described in “Retrieve Data Items that Constitute a Baseline Version” above. Each entry in the list includes the following information:
The stored delta value for the data item's current set of characteristics

In step 806, each delta value included the baseline list is stored, preferably in an in-memory data structure (such as a hash table) that permits efficient access to an object by specifying a key value. It is only necessary to insert the delta value in the data structure, using the delta value as the key value.

In step 807, it is determined if there are more entries in the source list. If so, the process continues with step 808, in which the process attempts to find the entry's delta value in the data structure created in 806.

In step 810, it is determined, based on the attempt to find the entry's delta value in the data structure in step 808, whether the delta value is present in the data structure. If so, this means that the current version of the data item is already present in the previous baseline version and the process continues with step 812, in which the delta value is removed from the data structure, so that the data item version will not be removed from the baseline in a later step. The process then returns to step 807 to determine if there are more entries in the source list.

If, in step 810, it is determined that the delta value is not present in the data structure, then the process continues with step 814, in which it is determined whether the data item corresponding to that delta value entry is present in the previous baseline version. If the data item is present in the previous baseline version, then the process continues with step 816, in which it is determined whether the data item has been modified in the baseline source, in which case, the “Update a Data Item Version in a Baseline Version” operation is performed. The process then returns to step 807 to determine if there are more entries in the source list.

If, in step 814, it is determined that the data item is not present in the previous baseline version, the process continues with step 818, in which the “Add a New Data Item Version to a Baseline Version” operation is performed. The process then returns to step 807 to determine if there are more entries in the source list.

When, in step 807, it is determined that no entries remain in the source list, each remaining entry in the data structure represents a data item that was present in the previous baseline version, but is not present in the baseline source. Thus, upon completion of steps 812, 816, or 818 for each entry in the baseline source list, the process continues with step 820, in which a variant of the “Remove a Data Item from a Baseline Version” operation is performed. In this variant of the operation, the data item to be removed is identified by its delta value rather than by its key characteristics.

It is to be noted that, in practice, the “Update a Data Item Version in a Baseline Version” operation will work for both steps 816 and 818, since “Update” is simply a “Remove” followed by an “Add,” and “Remove” does not report an error if there is nothing to remove.

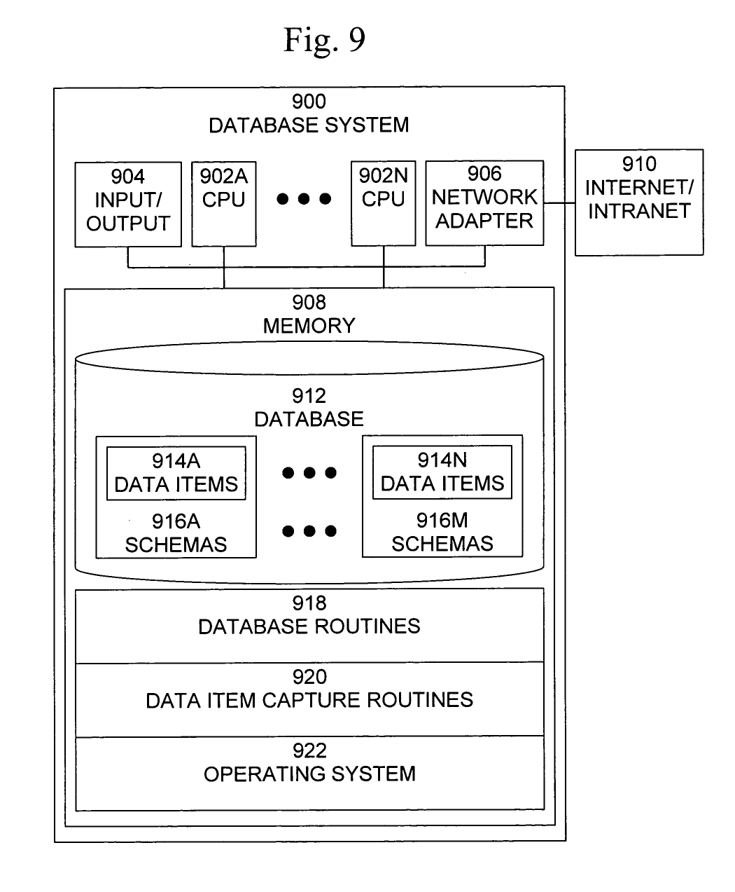

An exemplary block diagram of a database system 900, in which the present invention may be implemented, is shown in FIG. 9. System 900 is typically a programmed general-purpose computer system, such as a personal computer, workstation, server system, and minicomputer or mainframe computer. System 900 includes one or more processors (CPUs) 902A-902N, input/output circuitry 904, network adapter 906, and memory 908. CPUs 902A-902N execute program instructions in order to carry out the functions of the present invention. Typically, CPUs 902A-902N are one or more microprocessors, such as an INTEL PENTIUM® processor. FIG. 9 illustrates an embodiment in which system 900 is implemented as a single multi-processor computer system, in which multiple processors 902A-902N share system resources, such as memory 908, input/output circuitry 904, and network adapter 906. However, the present invention also contemplates embodiments in which system 900 is implemented as a plurality of networked computer systems, which may be single-processor computer systems, multi-processor computer systems, or a mix thereof.

Input/output circuitry 904 provides the capability to input data to, or output data from, database system 900. For example, input/output circuitry may include input devices, such as keyboards, mice, touchpads, trackballs, scanners, etc., output devices, such as video adapters, monitors, printers, etc., and input/output devices, such as, modems, etc. Network adapter 906 interfaces database system 900 with Internet/intranet 910. Internet/intranet 910 may include one or more standard local area network (LAN) or wide area network (WAN), such as Ethernet, Token Ring, the Internet, or a private or proprietary LAN/WAN.

Memory 908 stores program instructions that are executed by, and data that are used and processed by, CPU 902 to perform the functions of system 900. Memory 908 may include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

The contents of memory 908 varies depending upon the function that system 900 is programmed to perform. In the example shown in FIG. 9, memory 908 includes database 912, database routines 918, data item capture routines 920, and operating system 928. Database 912 includes a collection of information and other objects organized in such a way that computer software can select and retrieve desired pieces of data. Database routines 918 are software routines that provide the capability to store, organize, modify, and extract information from database 912. Database 912 includes a plurality of data items 914A-N, which may be organized in one or more schemas 916A-M. Data item capture routines 920 are software routines that provide the capability to capture and recapture data item versions. Operating system 922 provides overall system functionality.

As shown in FIG. 9, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNI®, OS/2®, and WINDOWS®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method of capturing and storing multiple versions of data item definitions in a database comprising:
generating a first version of information relating to a plurality of data item definitions in the database; and
generating a second version of information relating to a plurality of data item definitions in the database by recapturing only information relating to those data item definitions that have changed since the first version was generated.

2. The method of claim 1, wherein the first version is generated by capturing information relating to all data item definitions in the database.

3. The method of claim 1, wherein the first version is generated by capturing information relating to all data item definitions in the database meeting specified criteria.

4. The method of claim 1, wherein the first version is generated by:
obtaining information relating to a plurality of data item definitions, the information including at least one key characteristic value of the data item and a delta value for current characteristics of the data item; and
storing the information relating to each data item.

5. The method of claim 1, wherein the second version is generated by:
determining which data item definitions have changed since the first version was generated using an ordered list of data item definitions and associated delta values.

6. The method of claim 1, wherein the second version is generated by:
obtaining a first list of data items definitions in the database that meet the specified criteria, each entry in the list including at least one key characteristic of the data item and a delta value for current characteristics of the data item, wherein the list is ordered by values of the at least one key characteristic;
obtaining a second list of data item definitions in the first version, each entry in the list including at least one key characteristic of the data item as included in the first version and a delta value for characteristics of the data item as included in the first version, wherein the list is ordered by values of the at least one key characteristic; and
comparing the first list and the second list to determine which data item definitions have changed.

7. The method of claim 6, wherein comparing the first list and the second list to determine which data item definitions have changed is performed by, for each entry in the first list:
if the data item is present in the first list, but not present in the second list, adding the data item to the second version;
if the data item is present in the second list, but not present in the first list, removing the data item from the second version;
if the data item is present in the first list and in the second list, and if the delta value of the data item has changed, updating the data item in the second version; and
generating the second version by recapturing only information relating to those data items that have been added to or updated in the second version.

8. The method of claim 1, wherein the second version is generated by:
obtaining a first list of data items definitions in the database that meet the specified criteria, each entry in the list including at least one key characteristic of the data item and a delta value for current characteristics of the data item, wherein the list is unordered;
obtaining a second list of data item definitions in the first version, each entry in the list including a delta value for characteristics of the data item as included in the first version; and
comparing the first list and the second list to determine which data item definitions have changed.

9. The method of claim 8, wherein comparing the first list and the second list to determine which data item definitions have changed is performed by storing the delta values from the second list; then, for each entry in the first list:
if the delta value of the entry is present in the second list, removing the delta value from the stored delta values;
if the delta value of the entry is not present in the second list, if the data item corresponding to the entry is present in the first version, updating the data item in the second version;
if the delta value of the entry is not present in the second list, and if the data item corresponding to the entry is not present in the first version, adding the data item to the second version;
for all delta values remaining in the stored delta values, removing the data item having that delta value from the second version; and
generating the second version by recapturing only information relating to those data items with stored delta values that have been added to or updated in the second version.

10. The method of claim 9, wherein the delta values are stored in a hash table.

11. A database system for capturing and storing multiple versions of data item definitions comprising:
a processor operable to execute computer program instructions;
a memory operable to store computer program instructions executable by the processor, and
computer program instructions stored in the memory and executable to perform the steps of:
generating a first version of information relating to a plurality of data item definitions in the database; and
generating a second version of information relating to a plurality of data item definitions in the database by recapturing only information relating to those data item definitions that have changed since the first version was generated.

12. The system of claim 11, wherein the first version is generated by capturing information relating to all data item definitions in the database.

13. The system of claim 11, wherein the first version is generated by capturing information relating to all data item definitions in the database meeting specified criteria.

14. The system of claim 11, wherein the first version is generated by:
obtaining information relating to a plurality of data item definitions, the information including at least one key characteristic value of the data item and a delta value for current characteristics of the data item; and
storing the information relating to each data item.

15. The system of claim 11, wherein the second version is generated by:
determining which data item definitions have changed since the first version was generated using an ordered list of data item definitions and associated delta values.

16. The system of claim 11, wherein the second version is generated by:
obtaining a first list of data items definitions in the database that meet the specified criteria, each entry in the list including at least one key characteristic of the data item and a delta value for current characteristics of the data item, wherein the list is ordered by values of the at least one key characteristic;
obtaining a second list of data item definitions in the first version, each entry in the list including at least one key characteristic of the data item as included in the first version and a delta value for characteristics of the data item as included in the first version, wherein the list is ordered by values of the at least one key characteristic; and
comparing the first list and the second list to determine which data item definitions have changed.

17. The system of claim 16, wherein comparing the first list and the second list to determine which data item definitions have changed is performed by, for each entry in the first list:
if the data item is present in the first list, but not present in the second list, adding the data item to the second version;
if the data item is present in the second list, but not present in the first list, removing the data item from the second version;
if the data item is present in the first list and in the second list, and if the delta value of the data item has changed, updating the data item in the second version; and
generating the second version by recapturing only information relating to those data items that have been added to or updated in the second version.

18. The system of claim 11, wherein the second version is generated by:
obtaining a first list of data items definitions in the database that meet the specified criteria, each entry in the list including at least one key characteristic of the data item and a delta value for current characteristics of the data item, wherein the list is unordered;
obtaining a second list of data item definitions in the first version, each entry in the list including a delta value for characteristics of the data item as included in the first version; and
comparing the first list and the second list to determine which data item definitions have changed.

19. The system of claim 18, wherein comparing the first list and the second list to determine which data item definitions have changed is performed by storing the delta values from the second list; then, for each entry in the first list:
if the delta value of the entry is present in the second list, removing the delta value from the stored delta values;
if the delta value of the entry is not present in the second list, if the data item corresponding to the entry is present in the first version, updating the data item in the second version;
if the delta value of the entry is not present in the second list, and if the data item corresponding to the entry is not present in the first version, adding the data item to the second version;
for all delta values remaining in the stored delta values, removing the data item having that delta value from the second version; and
generating the second version by recapturing only information relating to those data items with stored delta values that have been added to or updated in the second version.

20. The system of claim 19, wherein the delta values are stored in a hash table.

21. A computer program product for capturing and storing multiple versions of data item definitions in a database, the computer program product comprising:
a computer readable medium;
computer program instructions, recorded on the computer readable medium, executable by a processor, for performing the steps of
generating a first version of information relating to a plurality of data item definitions in the database; and
generating a second version of information relating to a plurality of data item definitions in the database by recapturing only information relating to those data item definitions that have changed since the first version was generated.

22. The computer program product of claim 21, wherein the first version is generated by capturing information relating to all data item definitions in the database.

23. The computer program product of claim 21, wherein the first version is generated by capturing information relating to all data item definitions in the database meeting specified criteria.

24. The computer program product of claim 21, wherein the first version is generated by:
obtaining information relating to a plurality of data item definitions, the information including at least one key characteristic value of the data item and a delta value for current characteristics of the data item; and
storing the information relating to each data item.

25. The computer program product of claim 21, wherein the second version is generated by:
determining which data item definitions have changed since the first version was generated using an ordered list of data item definitions and associated delta values.

26. The computer program product of claim 21, wherein the second version is generated by:
obtaining a first list of data items definitions in the database that meet the specified criteria, each entry in the list including at least one key characteristic of the data item and a delta value for current characteristics of the data item, wherein the list is ordered by values of the at least one key characteristic;
obtaining a second list of data item definitions in the first version, each entry in the list including at least one key characteristic of the data item as included in the first version and a delta value for characteristics of the data item as included in the first version, wherein the list is ordered by values of the at least one key characteristic; and
comparing the first list and the second list to determine which data item definitions have changed.

27. The computer program product of claim 26, wherein comparing the first list and the second list to determine which data item definitions have changed is performed by, for each entry in the first list:
if the data item is present in the first list, but not present in the second list, adding the data item to the second version;
if the data item is present in the second list, but not present in the first list, removing the data item from the second version;
if the data item is present in the first list and in the second list, and if the delta value of the data item has changed, updating the data item in the second version; and
generating the second version by recapturing only information relating to those data items that have been added to or updated in the second version.

28. The computer program product of claim 21, wherein the second version is generated by:
obtaining a first list of data items definitions in the database that meet the specified criteria, each entry in the list including at least one key characteristic of the data item and a delta value for current characteristics of the data item, wherein the list is unordered;
obtaining a second list of data item definitions in the first version, each entry in the list including a delta value for characteristics of the data item as included in the first version; and
comparing the first list and the second list to determine which data item definitions have changed.

29. The computer program product of claim 28, wherein comparing the first list and the second list to determine which data item definitions have changed is performed by storing the delta values from the second list; then, for each entry in the first list:
if the delta value of the entry is present in the second list, removing the delta value from the stored delta values;
if the delta value of the entry is not present in the second list, if the data item corresponding to the entry is present in the first version, updating the data item in the second version;
if the delta value of the entry is not present in the second list, and if the data item corresponding to the entry is not present in the first version, adding the data item to the second version;
for all delta values remaining in the stored delta values, removing the data item having that delta value from the second version; and
generating the second version by recapturing only information relating to those data items with stored delta values that been added to or updated in the second version.

30. The computer program product of claim 29, wherein the delta values are stored in a hash table.
